(19) United States
(12) Patent Application Publication
(10) Pub. No.: US 2019/0159482 A1
(43) Pub. Date: May 30, 2019

(54) Healthy Starch and Fiber Juice and Food Mix

(71) Applicant: Peter Chukwuma Oparaugo, Hatboro, PA (US)

(72) Inventor: Peter Chukwuma Oparaugo, Hatboro, PA (US)

(21) Appl. No.: 16/207,079

(22) Filed: Nov. 30, 2018

Related U.S. Application Data
(60) Provisional application No. 62/592,535, filed on Nov. 30, 2017.

(51) Int. Cl. A23L 2/06; A23L 2/60; A23L 33/22; A23L 33/105

(52) U.S. Cl. CPC A23L 2/06; A23L 2/60; A23V 2002/00; A23L 33/105; A23L 33/22

(57) ABSTRACT

A method of producing a juice and food mix, and the product so formed. The first step in the method is the extraction of the juice and fiber mesh. Get the required amounts of the listed ingredients, then wash thoroughly with clean water and keep ready to be ground. Next, squeeze out the juice and add pure drinking water. Add the ingredients, and in slow gentle processing bring to fine fiber mesh. Add the juice mixture to the fine fiber mesh and stir-grind to bring to homogeneous mixture. Next extract or press out the dark green foamy juice from the fiber mesh cake. The fiber mesh cake is further dried, ground to green fiber flour and stored for use in the second step. The second step is mixing the dried green filler flour and flour/starch sourced from tubers or grains or seeds of choice. The mixture is used in foods.

### CROSS REFERENCE TO RELATED APPLICATION

This application is based on and claims the benefit of Provisional Patent Application Ser. No. 62/592,535, filed Nov. 30, 2017, which is incorporated herein by reference.

### BACKGROUND OF THE INVENTION

### 1. Field of the Invention

The present invention relates generally to a composition comprising a juice and an edible starch and fiber mixture, and a method for creating them. The juice and the mixture confer health benefits.

### 2. Description of the Prior Art

The present invention is a starch and fiber mix (for fufu or other foods) that enables wellness, improves optimum digestion of starchy foods and derivatives, reduce starchy food dependent constipation and associated food-to-stool transit time.

U.S. Pat. No. 3,649,292, issued on Mar. 14, 1972, to Babington A. Quame, discloses an overall method of producing valuable products from plantains, including fiber, amorphous carbon, inorganic salts, edible fiber and powder. This comprises steps of blending solid and liquid ingredients to create a fluid slurry, pressing the solid slurry and separating the liquid and solid materials from the slurry, making solid cakes out of the solid materials, and grinding the cake to a powder that can be used as an edible thickening agent. But it does not utilize the combination of components used in the instant invention.

U.S. Pat. No. 4,066,633, issued on Jan. 3, 1978, to Charles Gastineau, Olivier de Mathan and Jan-Dominique Dilly, discloses a process for the treatment of leafy green plants for the extraction of proteins in the pressing juices and an economic dehydration of cake. It comprises the steps of pressing liquid with a solid ingredient. It also comprises the method of separating the juice from the solid materials and compacting the solid materials into a cake. But it does not share any additional components with the instant invention.

U.S. Pat. No. 4,144,355, issued on Mar. 13, 1979, to Robert M. Rawlings and Donald Proctor, relates to waste streams of vegetable processing plants. One aspect of the invention relates to a process for treating aqueous slurries of vegetable waste materials containing starch and protein. Another aspect of the invention relates to an efficient, economical, and environmentally acceptable method of removing suspended solids from the vegetable-containing slurries produced in vegetable processing plants. However, it does not share any additional components or arrangements with the instant invention.

U.S. Pat. No. 4,775,477, issued on Oct. 4, 1988, to Howard D. Stahl, Michael E. Bordonaro and David Nini, discloses a process for extraction of cranberry press-cake is disclosed, which involves the steps of grinding the press-cake, subjecting the mixture to water extraction, and recovering a red-colored solution. It includes the step of extracting a juice from fruit, specifically cranberry. After the juice is extracted, the cranberry press-cake is formed from the remaining solid materials.

International Patent Publication No. WO 2005/072537, published on Aug. 11, 2005, to Access Business Group International LLC and Cognis Australia Pty. Ltd., discloses a process for producing a Kadadu plaum powder, having an increased amount of naturally occurring ascorbic acid and a high Oxygen Radical Absorption Capacity (“ORAC”). It comprises that steps of disintegrating solid ingredients, pressing the juice from the blended mixture, separating a concentrated plum juice, and creating a fiber mesh cake from the pressed mixture. The instant invention is distinguishable in that it includes the steps of grinding the cake and creating a powder. It is further distinguishable, in that it includes the steps of a flour or starch source from tubers or grains to the dried fiber mesh cake. And the instant invention utilizes a unique combination of ingredients.

International Patent Publication No. WO 2015/197078, published on Dec. 30, 2015, to Biotest APS and Aaborg Universitet, discloses a method of providing functional proteins from plant material. It relates to the provision of leaf protein concentrate and food grade soluable functional proteins, and possibly other high value products and fibers, from green plant material. It further provides for obtaining fermentation products, such as biogas and fertilizer. The soluble functional protein product may be used in food and/or pharmaceutical products. However, it does not share components or arrangements with the instant invention.

None of the above inventions and patents, taken either singly or in combination, is seen to describe the instant invention as claimed.

### SUMMARY OF THE INVENTION

The present invention is a method of producing a juice and food mix, and the product so formed. The first step in the method is the extraction of the juice and fiber mesh. Get the required amounts of the listed ingredients, then wash thoroughly with clean water and keep ready to be ground. Next, squeeze out the juice and add pure drinking water. Add the ingredients, and in slow gentle processing bring to fine fiber mesh. Add the juice mixture to the fine fiber mesh and stir-grind to bring to homogeneous mixture. Next extract or press out the dark green foamy juice from the fiber mesh cake. The fiber mesh cake is further dried, ground to green fiber flour and stored for use in the second step. The second step is mixing the dried green filler flour and flour/starch sourced from tubers or grains or seeds of choice. The mixture is used in various foods.

Accordingly, it is a principal object of the invention to improve overall wellness.

It is another object of the invention to enable optimum digestion.

It is a further object of the invention to reduce constipation.

Still another object of the invention is to reduce food-to-stool transit time.

It is an object of the invention to provide improved elements and arrangements thereof in a composition and method for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an illustrative drawing of a user pounding ingredients with a motor in a traditional manner to practice the invention, although modern machinery may also be used to practice the invention.

FIG. 2 is a flowchart of the extraction of the juice.

FIG. 3 is a flowchart of the mixing process.

Similar reference characters denote corresponding features consistently throughout the attached drawings. All illustrations of the drawings are for the purpose of describing selected versions of the present invention and are not intended to limit the scope of the present invention.

### DETAILED DESCRIPTION OF THE PREFERRED EMBODIMENTS

The ingredients and quantities for the recipe of the present invention are listed below:

| INGREDIENTS | | QUANTITY | |
|---|---|---|---|
| 1. | UGU (Telfairia occidentalis: fluted gourd leaves) | 100 | grams |
| 2. | OLUGBU (Vernonia amygdalina: bitter leaf) | 100 | grams |
| 3. | UTAZI (Gongronema latifolium: bush buck) | 100 | grams |
| 4. | OKAZI (Gnetum africanum: wild spinach) | 100 | grams |
| 5. | OHA (Pterocarpus mildbraedii: harms) | 100 | grams |
| 6. | OPE (Solanium marcrocarpon: African | 100 | grams |
| | eggplant leaf) | | |
| 7. | OGIRISI (Newbouldia laevis: African life tree) | 100 | grams |
| 8. | OPETE (Costus afer: ginger lily) | 100 | grams |
| 9. | UZIZA (Piper guineense: false cubed leaves) | 50 | grams |
| 10. | NCHUANWU (Ocimum gratissimum: clove basil) | 100 | grams |
| 11. | EKOH (Mentha: mint leaves) | 50 | grams |
| 12. | EDE MMEE (Beta vulgaris: beet root) | 100 | grams |
| 13. | AKWUKWO MMIRI (Talinum triangulare: | 100 | grams |
| | water leaf) | | |
| 14. | ININE NDU (Amaranthus hybridus: | 100 | grams |
| | green amaranth) | | |
| 15. | OROMA NKIRISI (several species: lime) | 5 | pieces |
| 16. | OROMA UKWU (Citrus paradise: grapefruit) | 2 | pieces |
| 17. | FLOUR/STARCH SOURCED FROM | | |
| | TUBERS OR GRAINS OR SEEDS OF CHOICE | | |

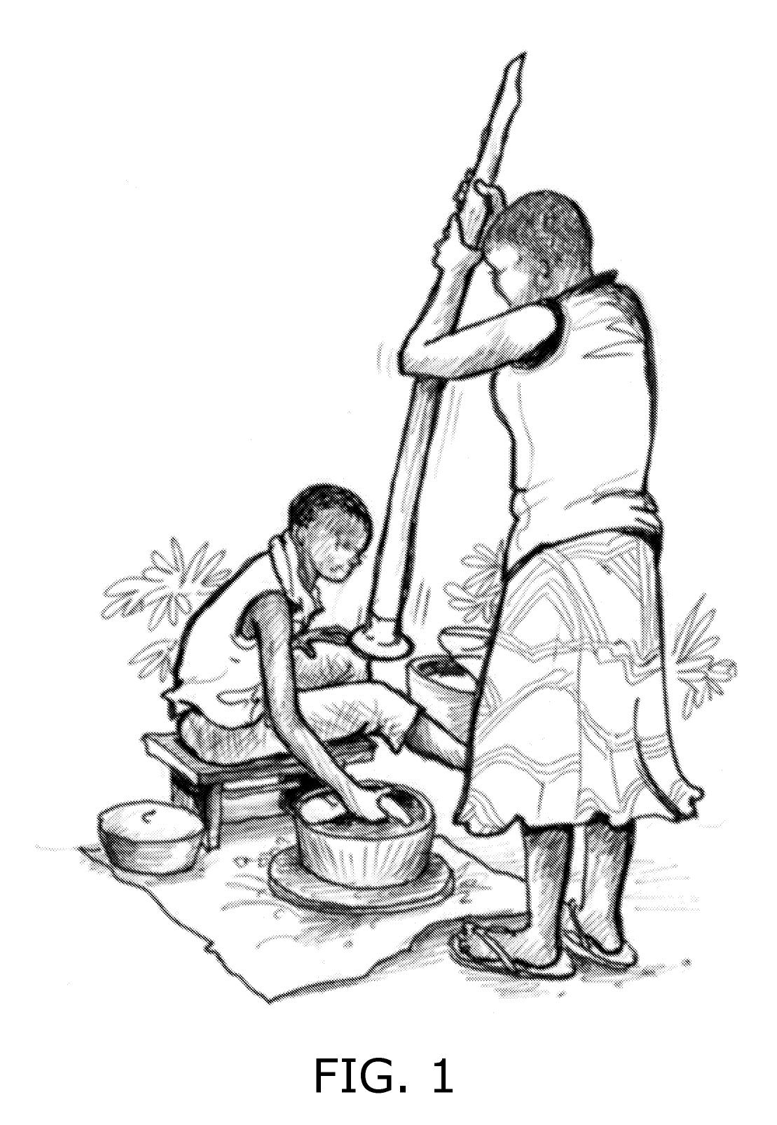

The first name given for each item 1-16 is its name in Igbo (a language spoken in southeastern Nigeria), the second name is its scientific name, and the third name is its common English name. The exact quantities of these ingredients may be varied, but it is preferable that they be varied proportionately. For example, if one ingredient is doubled in quantity, then all ingredients should be doubled; if one ingredient is halved in quantity, then they should all be halved. FIG. 1, shows a traditional method of grinding said ingredients, though modern machinery may also be used.

### Step 1: Extraction of the Juice and Fiber Mesh

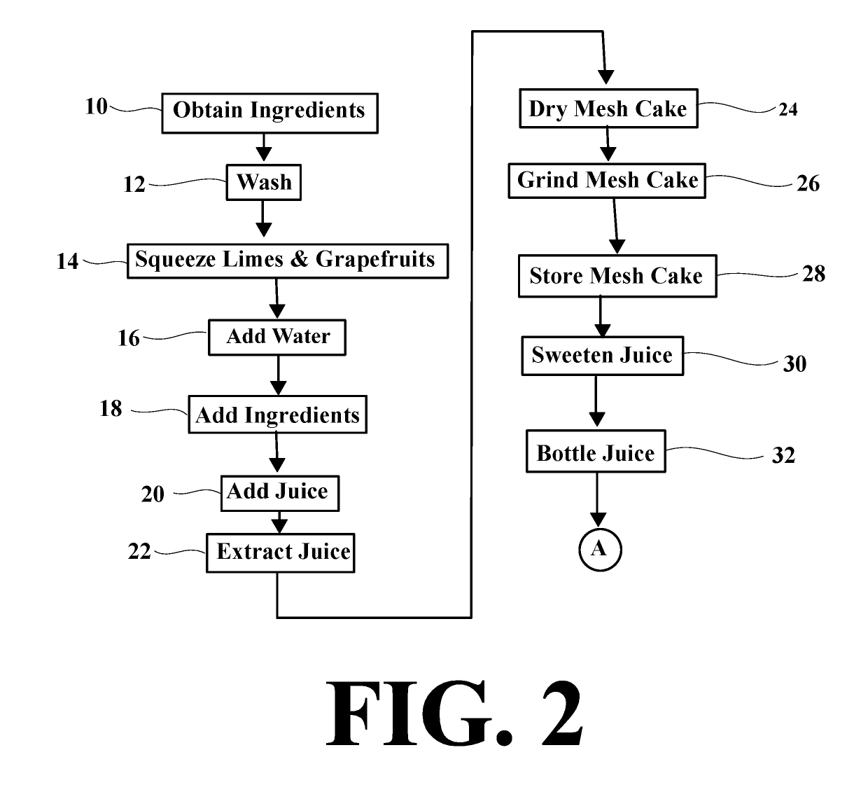

FIG. 2 is a flowchart of step 1:

A) Get the required amounts of the ingredients 10 in #1-14: UGU, OLUGBU, UTAZI, OKAZI, OHA, AKUGBA, OGIRISI, OPETE, UZUZA, EKOH, EDE MMEE (BEET ROOT) AKWUKWO MMIRI (WATER LEAF/CREST) AKWUKWO NDU (GREEN) summing up to 1.3 kg. Then wash thoroughly with clean water 12 and keep ready to be ground in a wooden or stone imortar, manual food grinder, electric grinder, food processor, commercial food grinder electric juicer or any electrical device to get these items blended.

B) Next, squeeze out the juice of the 5 oroma nkirisi (limes) and 2 of oroma ukwu (grapefruits) of ingredients #15-16 14 and add pure drinking water 16 to bring the total volume to 1.5 liter of water-citrus juice mixture.

C) Add the ingredients #1-14 to the wooden or stone mortar, manual food grinder, electric grinder, food processor, commercial food grinder or electric juicer of choice and in slow gentle processing bring to fine fiber mesh (FIG. 1, 18).

D) Add the 1.5 liter of water-citrus juice mixture to the 1.3 kg fine fiber mesh (FIG. 1, 20) and stir-grind to bring to homogeneous mixture.

E) Next use a cheese cloth or wine press to extract or press out the dark green foamy juice of approx. 2.2 liter in final volume 22 and yield of approx. 700 grams of fiber mesh cake. The fiber mesh cake is further dried 24, ground to green fiber flour 26 and stored 28 for use in step 2. The green juice (MMIRI NDU) may now be sweetened with honey, sugar or any sweetener of choice 30 and bottled ready to drink at will as preferred 32.

Step 2: Mixing the Dried Green Fiber Flour and Flour/Starch Sourced from Tubers or Grains or Seeds of Choice

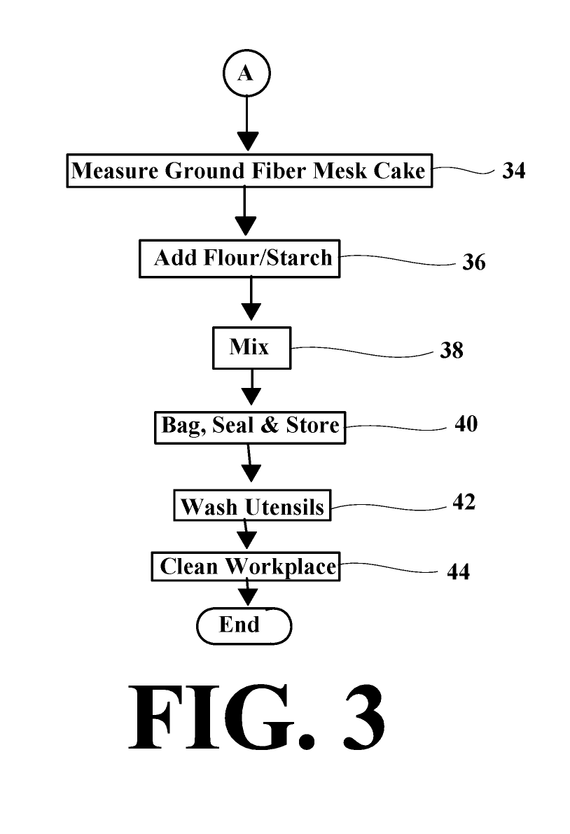

FIG. 3 is a flowchart of step 2:

A) Add to every 1 portion of the DRIED GREEN FIBER FLOUR 34, 3 portions of (Ingredient #17) FLOUR/STARCH SOURCED FROM TUBERS OR GRAINS OR SEEDS OF CHOICE 36, and mix 38. Thus, this ratio of 1:3 may be varied to maintain certain percentages of green fiber contents of the STARCH-N-FIBER FUFU MIX. This mix is then bagged, sealed and stored 40 to be used at will to make foods such as fufu, eba swallows, to thicken stews, for broths, soup balls, meat balls etc.

B) Wash all utensils 42 and keep a clean workplace 44.

The end products include prepackaged derivative mixes for instant high edible fiber—STARCH-N-FIBER FUFU MIX and WELLNESS JUICE DRINKS (MMIRI NDU) as nutrition supplements for consumption. The high fiber content of this STARCH-N-FIBER FUFU MIX and derivatives enables wellness, improves optimum digestion of starchy foods and derivatives, reduce starchy food dependent constipation and associated food-to-stool transit time.

Although the invention has been explained in relation to its preferred embodiments, it is to be understood that many other possible modifications and variations can be made without departing from the spirit and scope of the invention. It is to be understood that the present invention is not limited to the embodiments described above, but encompasses any and all embodiments within the scope of the following claims.

I claim:

1. A process for preparing an edible substance, comprising the steps of:
obtaining 100 grams each of plant parts from the species Telfairia occidentalis, Vernonia amygdalina, Gongronema latifolium, Gnetum africanum, Pterocarpus mildbraedii, Solanium marcrocarpon, Newbouldia laevis, Costus afer, Ocimum gratissimum, Beta vulgaris, Talinum triangulare, and Amaranthus hybridus;
obtaining 50 grams each of plant parts from the species Piper guineense and the genus Mentha;
washing said plant parts with clean water;
grinding and blending said plant parts;
squeezing out the juice from five limes and two grapefruits, and add pure drinking water to the juice to bring the juice/water mixture to a total volume of 1.5 liters;
adding the juice/water mixture to the ground and blended plant parts, and stir to form a homogenous mixture;
extracting liquid juice from the homogenous mixture;
sweetening and bottling the liquid juice;
drying, grinding and storing the remaining solid part of the homogenous mixture as fiber flour;
to a portion of the fiber flour, adding three portions of a starch flour sourced from plant parts selecting from the group consisting essentially of tubers, grains and seeds to form a food mix.

2. A juice, comprising:
liquid extracted from a homogenous mixture, that has been sweetened and bottled;
wherein the homogenous mixture has been formed by:
obtaining 100 grams each of plant parts from the species Telfairia occidentalis, Vernonia amygdalina, Gongronema latifolium, Gnetum africanum, Pterocarpus mildbraedii, Solanium marcrocarpon, Newbouldia laevis, Costus afer, Ocimum gratissimum, Beta vulgaris, Talinum triangulare, and Amaranthus hybridus;
obtaining 50 grams each of plant parts from the species Piper guineense and the genus Mentha;
washing said plant parts with clean water;
grinding and blending said plant parts;
squeezing out the juice from five limes and two grapefruits, and add pure drinking water to the juice to bring the juice/water mixture to a total volume of 1.5 liters;
adding the juice/water mixture to the ground and blended plant parts, and stirring to form the homogenous mixture.

3. A food mix, comprising:
a portion of a fiber flour, added to three portions of a starch flour sourced from plant parts selecting from the group consisting essentially of tubers, grains and seeds, and mixed together;
wherein the fiber flour is formed by:
obtaining 100 grams each of plant parts from the species Telfairia occidentalis, Vernonia amygdalina, Gongronema latifolium, Gnetum africanum, Pterocarpus mildbraedii, Solanium marcrocarpon, Newbouldia laevis, Costus afer, Ocimum gratissimum, Beta vulgaris, Talinum triangulare, and Amaranthus hybridus;
obtaining 50 grams each of plant parts from the species Piper guineense and the genus Mentha;
washing said plant parts with clean water;
grinding and blending said plant parts;
squeezing out the juice from five limes and two grapefruits, and add pure drinking water to the juice to bring the juice/water mixture to a total volume of 1.5 liters;
adding the juice/water mixture to the ground and blended plant parts, and stirring to form a homogenous mixture;
extracting liquid juice from the homogenous mixture;
drying, grinding and storing the remaining solid part of the homogenous mixture as the fiber flour.
